(19) United States
(12) Patent Application Publication
(10) Pub. No.: US 2025/0056509 A1
(43) Pub. Date: Feb. 13, 2025

(54) MULTI-CONSECUTIVE SLOTS TRANSMISSION

(71) Applicant: Nokia Technologies Oy, Espoo (FI)

(72) Inventors: Nuno Manuel KIILERICH PRATAS, Aalborg (DK); Renato Barbosa ABREU, Aalborg (DK); Thomas Haaning JACOBSEN, Aalborg (DK); Yong LIU, Shanghai (CN); Jakob Lindbjerg BUTHLER, Aalborg (DK)

(21) Appl. No.: 18/774,059

(22) Filed: Jul. 16, 2024

(30) Foreign Application Priority Data
Aug. 7, 2023 (WO) PCT/CN2023/111599

(51) Int. Cl. H04W 72/0446; H04W 72/40

(52) U.S. Cl. CPC H04W 72/0446; H04W 72/40

(57) ABSTRACT

Embodiments of the present disclosure relate to apparatuses, methods, and computer readable storage media for multi-consecutive slots transmission (Multi-consecutive slots transmission). An apparatus obtains at least one group of single-slot candidate resources available for a sidelink transmission. The apparatus determines, based on a first number of slots for multi-consecutive slots transmission, a first set of multi-consecutive slots transmission candidate resources from the at least one group of single-slot candidate resources, a multi-consecutive slots transmission candidate resource comprising the first number of consecutive slots. If the first set of multi-consecutive slots transmission candidate resources meets at least one multi-consecutive slots transmission candidate resource condition, the apparatus selects a target resource for transmission of the multi-consecutive slots transmission from the first set of multi-consecutive slots transmission candidate resources. Otherwise, the apparatus determines the target resource for transmission of the multi-consecutive slots transmission based on a multi-consecutive slots transmission criterion.

### FIELDS

Various example embodiments of the present disclosure generally relate to the field of telecommunication and in particular, to methods, devices, apparatuses and computer readable storage medium for multi-consecutive slots transmission.

### BACKGROUND

Multi-consecutive slots transmission, which is also called MCSt, has been supported for Mode 1 and Mode 2 resource allocation in sidelink unlicensed (SL-U) communication. Multi-consecutive slots transmission may help reduce the need or frequency of UE performing Listen-Before-Talk (LBT) to access the channel once it has acquired a Channel Occupancy Time (COT), and retain the COT to transmit UE's data as much as and as soon as possible in the following slots.

From the perspective of UE, the higher layer (e.g., the MAC layer) may trigger the layer 1 (L1) to report candidate resources for one or more transport blocks (TBs). The candidate resources are usually single-slot resources. Since the resource selection at the higher layer is randomly performed, it may not be easy to select a set of resources consecutive in time that meets a specific multi-consecutive slots transmission length.

### SUMMARY

In a first aspect of the present disclosure, there is provided an apparatus. The apparatus comprises at least one processor; and at least one memory storing instructions that, when executed by the at least one processor, cause the apparatus at least to: obtain at least one group of single-slot candidate resources available for a sidelink transmission; determine, based on a first number of slots for multi-consecutive slots transmission, a first set of multi-consecutive slots transmission candidate resources from the at least one group of single-slot candidate resources, a multi-consecutive slots transmission candidate resource comprising the first number of consecutive slots; determine that the first set of multi-consecutive slots transmission candidate resources meets at least one multi-consecutive slots transmission candidate resource condition; select a target resource for transmission of the multi-consecutive slots transmission from the first set of multi-consecutive slots transmission candidate resources; and transmit the multi-consecutive slots transmission on the target resource.

In a second aspect of the present disclosure, there is provided a method. The method comprises: obtaining, at an apparatus, at least one group of single-slot candidate resources available for a sidelink transmission; determining, based on a first number of slots for multi-consecutive slots transmission, a first set of multi-consecutive slots transmission candidate resources from the at least one group of single-slot candidate resources, a multi-consecutive slots transmission candidate resource comprising the first number of consecutive slots; determining that the first set of multi-consecutive slots transmission candidate resources meets at least one multi-consecutive slots transmission candidate resource condition; selecting a target resource for transmission of the multi-consecutive slots transmission from the first set of multi-consecutive slots transmission candidate resources; and transmitting the multi-consecutive slots transmission on the target resource.

In a third aspect of the present disclosure, there is provided an apparatus. The apparatus comprises means for obtaining at least one group of single-slot candidate resources available for a sidelink transmission; means for determining, based on a first number of slots for multi-consecutive slots transmission, a first set of multi-consecutive slots transmission candidate resources from the at least one group of single-slot candidate resources, a multi-consecutive slots transmission candidate resource comprising the first number of consecutive slots; means for in accordance with a determination that the first set of multi-consecutive slots transmission candidate resources meets at least one multi-consecutive slots transmission candidate resource condition, selecting a target resource for transmission of the multi-consecutive slots transmission from the first set of multi-consecutive slots transmission candidate resources; means for in accordance with a determination that the first set of multi-consecutive slots transmission candidate resources does not meet the at least one multi-consecutive slots transmission candidate resource condition, determining the target resource for transmission of the multi-consecutive slots transmission based on a multi-consecutive slots transmission criterion on a set size and/or a change of the first number of slots; and means for transmitting the multi-consecutive slots transmission on the target resource.

In a fourth aspect of the present disclosure, there is provided a computer readable medium. The computer readable medium comprises instructions stored thereon for causing an apparatus to perform at least the method according to the third aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a flowchart of a method implemented at an apparatus according to some example embodiments of the present disclosure;

FIG. 3 illustrates a flowchart of a method implemented at an apparatus according to some example embodiments of the present disclosure;

FIG. 4 illustrates a schematic diagram of example resource selection of multi-consecutive slots transmission candidate resources;

FIG. 5 illustrates a schematic diagram of example resource selection of multi-consecutive slots transmission candidate resources;

FIG. 6 illustrates a flowchart of a method implemented at an apparatus according to some example embodiments of the present disclosure;

FIG. 7 illustrates a schematic diagram of example resource selection of multi-consecutive slots transmission candidate resources for transmission of multiple TBs;

FIG. 8 illustrates a schematic diagram of example resource selection of multi-consecutive slots transmission candidate resources from multiple RB sets;

FIG. 9 illustrates a schematic diagram of example resource selection of multi-consecutive slots transmission candidate resources from multiple RB sets;

FIG. 10 illustrates a simplified block diagram of a device that is suitable for implementing example embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

In legacy behaviors of UE (e.g., in Rel-16 or Rel-17), upon receiving a set of candidate resources from the PHY, the MAC may randomly select from the set of candidate resources for its SL transmission. Instead of selecting the first resource available in time, random selection helps to ensure that multiple transmissions from different UEs are spread in time and frequency domains, and thus avoiding a congestion that would occur due to intentional selection of the earliest available resources by all UEs.

However, as previously discussed, random selection may not be suitable for a multi-consecutive slots transmission, as the candidate resource should meet a specific length, i.e., a number of slots for multi-consecutive slots transmission.

One possible reasonable way to achieve the multi-consecutive slots transmission is to apply a certain criterion, such as, a consecutive-slot criterion. On the other hand, applying the consecutive-slot criterion in resource selection may significantly reduce the number of candidate resources and thus also the randomness in resource selection, which would in turn causes the congestion in the SL channel again.

Therefore, the consecutive-slots criterion realization should take this into account, i.e., the resource selection algorithm that applies this criterion should ensure that the candidate resources are selected to cause multiple multi-consecutive slots transmissions from individual UEs, when seen in a group, to be spread in time and not all piled up in time and frequency domains, especially from the perspective of an external observer. In view of this, the multi-consecutive slots transmission in SL needs improvements at least in term of resource selection.

Example embodiments of the present disclosure will be described in detail below with reference to the accompanying drawings.

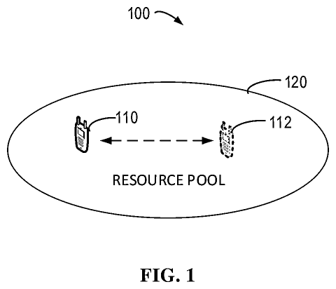

FIG. 1 illustrates an example communication environment 100 in which example embodiments of the present disclosure can be implemented. The communication environment 100 may support SL communications among terminal devices. As shown in FIG. 1, the communication environment 100 may comprise a plurality of terminal devices 110 and 112 (e.g., UE).

The terminal devices 110 and 112 may communicate with each other via SL communication. In the example of FIG. 1, the terminal devices 110 and 112 may select resources for their SL transmission from a set of preconfigured or predetermined candidate resources, which is also called a resource pool 120. In some example embodiments, the resource pool 120 may span over multiple LBT channels (e.g., of 20 MHz), and thus multiple resource block (RB) sets may be configured.

Taking the terminal device 110 as an example, its higher layer (e.g., the MAC layer) triggers L1 (e.g., the PHY layer) resource selection for one or multiple TBs to be transmitted. As a response, L1 may report a set of candidate resources available for the one or multiple TBs. The set of candidate resources may be single-slot resources.

In some example embodiments, the one or multiple TBs may be transmitted in multi-consecutive slots in time domain, which is also called multi-consecutive slots transmissions. Accordingly, the higher layer selects target resources from the set of candidate resources based on at least one multi-consecutive slots transmission condition and/or criterion. The at least one multi-consecutive slots transmission condition and/or criterion may ensure that the selected resources have a certain length in slots and conform an expected distribution in time domain and/or frequency domain, which will be discussed in detail later.

In the context of the embodiments of the present disclosure, the terminal device 112 may or may not use the same multi-consecutive slots transmission condition and/or criterion as the terminal device 110. Thus, the present disclosure is not limited in this regard.

It should be noted that, in some example embodiments, operations described in connection with a terminal device may be implemented at a network device or other device, and operations described in connection with a network device may be implemented at a terminal device or other device.

It is to be understood that the number of apparatuses and their connections shown in FIG. 1 are only for the purpose of illustration without suggesting any limitation. The communication network 100 may include any suitable number of apparatuses configured to implementing example embodiments of the present disclosure. Although not shown, it would be appreciated that one or more additional apparatuses and connections may be deployed in the communication network 100.

In some example embodiments, a link from a terminal device (e.g., terminal device 110 or 112) to a network device (not shown) is referred to as a downlink (UL), and a link from the network device to the terminal device is referred to as an uplink (DL). In DL, the network device is a transmitting (TX) device (or a transmitter) and the terminal device is a receiving (RX) device (or a receiver). In UL, the terminal device is a TX device (or a transmitter) and the network apparatus is a RX device (or a receiver). In SL, the terminal device may be both a RX device and a TX device. For example, if the terminal device 110 transmits a SL transmission to the terminal device 112, the terminal device 110 is the TX device, and the terminal device 112 is the RX device. On the contrary, if the terminal device 112 transmits a SL transmission to the terminal device 110, the terminal device 112 is the TX device, and the terminal device 110 is the RX device.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

According to the example embodiments of the present disclosure, a solution of resource selection for multi-consecutive slots transmission is provided. In particular, the MAC layer adopts certain consecutive-slots criterion and/or condition to determine which of the candidate resources to be used for multi-consecutive slots transmission.

With the consecutive-slots criterion, the MAC layer can identify a set of multi-consecutive slots transmission candidate resources consisting of one or more combinations of single-slot candidate resources that are consecutive in time domain and meet a target number of slots. The MAC layer then evaluates if the set of multi-consecutive slots transmission candidate resources meets certain conditions. If so, the MAC layer may randomly select one from the set of multi-consecutive slots transmission candidate resources for multi-consecutive slots transmission. Otherwise, the MAC layer may change the target number of slots and reidentify the multi-consecutive slots transmission candidate resources until the result meets the certain condition. In this way, the resource selection for multi-consecutive slots transmission can be efficiently achieved without introducing congestions among multiple UEs.

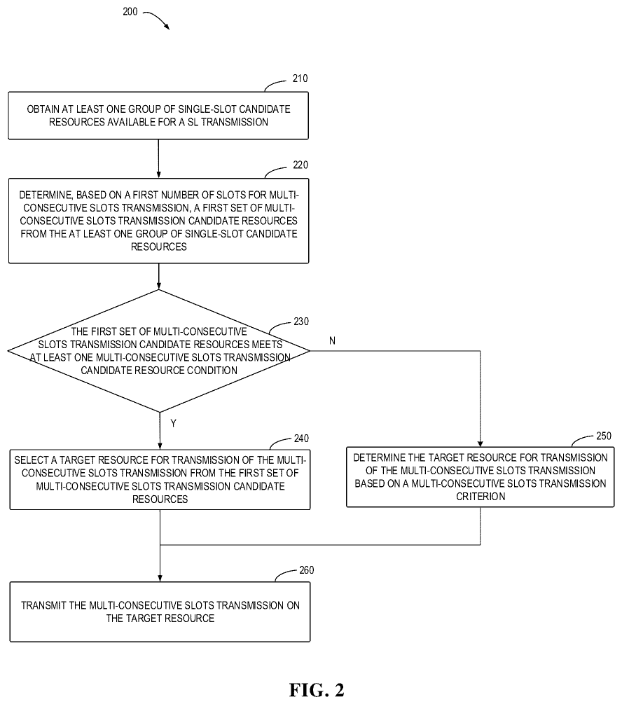

Reference is now made to FIG. 2, which illustrates a flowchart of a method 200 implemented at an apparatus according to some example embodiments of the present disclosure. As shown in FIG. 2, the method 200 involves at least the terminal apparatus 110. For the purpose of discussion, reference is made to FIG. 1 to describe the method 200.

Before performing any SL transmission in the SL channel, the terminal device 110 needs to select resources from the configured resource pool 120. The resource pool 120 may be shared with other terminal devices, such as the terminal device 112. In the method 200, the sidelink transmission may be in form of a multi-consecutive slots transmission that is to be transmitted on two or more consecutive slots in time domain, while the sub-channel allocation in each slot may be different. For the single TB case, the number of sub-channels is the same in each single-slot candidate resource, but these can occur at different sub-channels. While for the multiple TB case, the number of sub-channels may vary from TBs, and they can occur at different sub-channels.

At block 210, the terminal apparatus 110 obtains at least one group of single-slot candidate resources available for a SL transmission.

As previously described, the MAC layer of the terminal device 110 may trigger L1 resource selection for SL transmission, which may correspond to one or more TBs. The resource selection for each TB may be triggered separately. Accordingly, the L1 may report at least one group of candidate resources available for SL transmission. In case of multiple TBs, there may be a plurality of groups of candidate resources. The candidate resources reported from L1 are single-slot resources. As a result, the MAC layer may obtain the single-slot candidate resources from L1.

At block 220, the terminal apparatus 110 determines, based on a first number of slots for multi-consecutive slots transmission, denoted by N_{slotMCSt_1}, a first set of multi-consecutive slots transmission candidate resources from the at least one group of single-slot candidate resources. A multi-consecutive slots transmission candidate resource may comprise the first number of consecutive slots.

In this way, the MAC layer of the terminal apparatus 110 identifies all the possible combinations of single-slot candidate resources that are consecutive in time domain and have a length of the first number of slots, N_{slotMCSt_1}. In the context of the embodiments, the first number of slots N_{slotMCSt_1} may refer to an initial value of a target number of slots when starting the resource selection. Depending on whether the set of multi-consecutive slots transmission candidate resources generated based on the first number of slots N_{slotMCSt_1} meets certain conditions and/or criterion, the value of the target number of slots may be changed.

In some example embodiments, for a single TB, the MAC layer may identify all the possible combinations of single-slot candidate resources that occupy a target number of consecutive slots from the at least one group of single-slot candidate resources provided by L1 for that TB.

Alternatively, for multiple TBs, the MAC layer may identify all the possible combinations of single-slot candidate resources that occupy a target number of consecutive slots across a plurality of groups of single-slot candidate resources provided by L1 for each of the multiple TBs.

At block 230, the terminal apparatus 110 determines whether the first set of multi-consecutive slots transmission candidate resources meets at least one multi-consecutive slots transmission candidate resource condition.

For example, the at least one multi-consecutive slots transmission candidate resource condition comprises at least one of the following:
a size of the first set of multi-consecutive slots transmission candidate resources is above a threshold size,
the first set of multi-consecutive slots transmission candidate resources is evenly distributed within a selection window in time domain and/or frequency domain,
at least a part of the first set of multi-consecutive slots transmission candidate resources meets a preconfigured separation in the time domain to any other multi-consecutive slots transmission candidate resource in the first set of multi-consecutive slots transmission candidate resources, e.g., for HARQ retransmission of multi-consecutive slots transmission.

In some example embodiments, the threshold size may be preconfigured. Alternatively, in some other embodiments, the threshold size may be determined based on a ratio of resources in a resource selection window, e.g., a minimum size is Y % of the number of single-slot candidate resources in the resource selection window.

In some example embodiments, the terminal device 110 may average the time and frequency indices across all the multi-consecutive slots transmission candidate resources and then determine if the delta between that value and the time and frequency index of the slot in the middle of the selection window is within a preconfigured range.

Additionally, or alternatively, in some example embodiments, the multi-consecutive slots transmission candidate resources may be considered to be uniformly distributed within the selection window if each fraction of the selection window contains a minimum fraction of the generated the multi-consecutive slots transmission candidate resources, e.g., each ¼ of the selection window contains at least ⅕ of the multi-consecutive slots transmission candidate resources.

Additionally, or alternatively, in some other embodiments, the multi-consecutive slots transmission candidate resources may be considered to be uniformly distributed within the selection window, e.g., based on a frequency test of uniformity, such as, a chi-square test or a Kolmogorov-Smirnov test.

If the first set of multi-consecutive slots transmission candidate resources meets at least one multi-consecutive slots transmission candidate resource condition, at block 240, the terminal apparatus 110 selects a target resource for the multi-consecutive slots transmission from the first set of multi-consecutive slots transmission candidate resources.

Otherwise, if the first set of multi-consecutive slots transmission candidate resources does not meet the at least one multi-consecutive slots transmission candidate resource condition, at block 250, the terminal apparatus 110 determines the target resource for transmission of the multi-consecutive slots transmission based on a multi-consecutive slots transmission criterion on a set size and/or a change of the first number of slots.

At block 260, the terminal device 110 may then transmit the multi-consecutive slots transmission on the target resource that consists of the first number of consecutive slots. In a case where the sidelink transmission comprises a single TB, the first set of multi-consecutive slots transmission candidate resources is determined from a group of single-slot candidate resources, the TB may be repeated in each of the first number of consecutive slots. Alternatively, the TB may be spread across the first number of consecutive slots.

In a case where the sidelink transmission comprises a plurality of TBs, the first set of multi-consecutive slots transmission candidate resources may be determined from a plurality of groups of single-slot candidate resources, each of the plurality of TBs may be repeated in a different one of the first number of consecutive slots. Alternatively, each of the plurality of TB may be spread across the first number of consecutive slots.

There may be a lower target number of slots that indicates a minimum number of slots for the multi-consecutive slots transmission, and a required or higher target number of slots that indicates a maximum number of slots for the multi-consecutive slots transmission.

For determination of the required target number of slots for multi-consecutive slots transmission, different implementations may be considered. In some example embodiments, the required target number of slots may be determined based on a desired duration of COT corresponding to a channel access priority class (CAPC) associated with the sidelink transmission.

In some other embodiments, the required target number of slots may be determined based on a periodicity of physical sidelink feedback channel (PSFCH) associated with the sidelink transmission.

In still another embodiment, the required target number of slots may be determined based on a congestion metric of a channel busy ratio (CBR) associated with the sidelink transmission. For example, a length of the required target number of slots may be lower than a predetermined value, if CBR is above a CBR threshold. In yet another embodiment, the required target number of slots may be determined based on an amount of data in the buffer of the terminal device 110, which may need a number of slots to be transmitted.

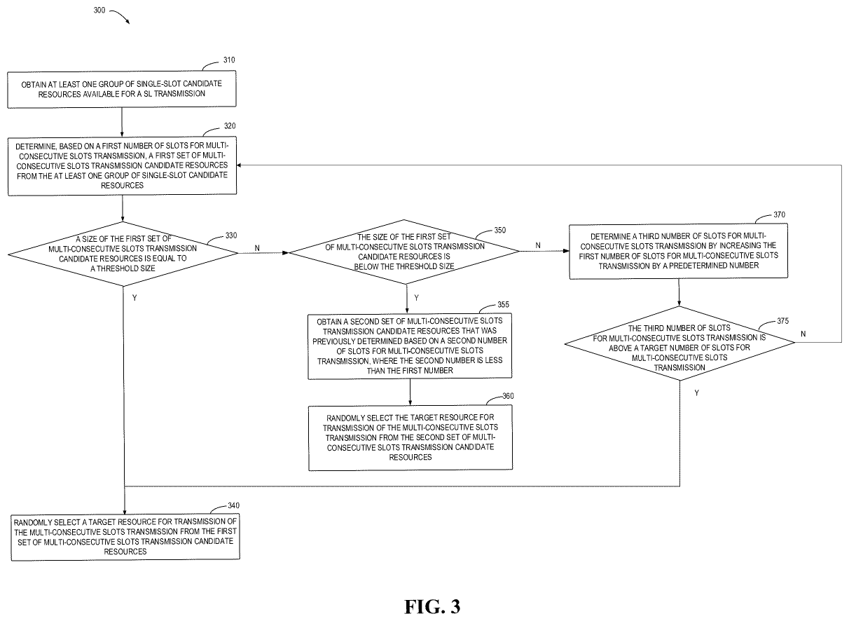

Depending on starting from the lower target number of slots or the higher target number of slots, the sub-steps in the method 200 may be different, which will be discussed in connection with FIGS. 3 to 6.

Reference is now made to FIG. 3, which illustrates a flowchart of a method 300 for resource selection that starts from a minimum number of slots for the multi-consecutive slots transmission. The method 300 may be implemented at an apparatus, for example, the terminal device 110. For the purpose of discussion, reference is made to FIG. 1 to describe the method 300.

Operations at blocks 310 and 320 are similar to those at blocks 210 and 220 in FIG. 2, thus details are not repeated herein. In the method 300, the first number of slots for multi-consecutive slots transmission N_{slotMCSt_1} is the lower target number of slots. The terminal device 110 may attempt to increment the lower target number of slots to the required number of slots for multi-consecutive slots transmission. This may be realized by an iterative sequence of steps for determining a feasible set of multi-consecutive slots candidate resource set.

By way of example, the first number of slots for multi-consecutive slots transmission may be 2, that is, N_{slotMCSt_1}=2. Accordingly, the terminal device 110 identifies all the possible combinations of 2 consecutive slots from the reported single-slot candidate resources, which forms the first set of multi-consecutive slots transmission candidate resources.

FIG. 4 illustrates a schematic diagram of example resource selection 400 of multi-consecutive slots transmission candidate resources, where N_{slotMCSt_1}=2. As shown in FIG. 4, the first set of multi-consecutive slots transmission candidate resources comprises multi-consecutive slots transmission candidate resources 401 to 406.

Similar to block 230, the terminal device 110 may then determine if the first set of multi-consecutive slots transmission candidate resources meet the at least one multi-consecutive slots transmission candidate resource condition.

In some example embodiments, the at least one multi-consecutive slots transmission candidate resource condition may comprise a size of the first set of multi-consecutive slots transmission candidate resources being above a threshold size. If so, the method 300 may proceed to block 340, i.e., the terminal device 110 may randomly select a target resource from the first set of multi-consecutive slots transmission candidate resources being above a threshold size.

In some example embodiments, the at least one multi-consecutive slots transmission candidate resource condition may comprise the size of the first set of multi-consecutive slots transmission candidate resources being equal to the threshold size. Accordingly, at block 330, the terminal device 110 determines if the size of the first set of multi-consecutive slots transmission candidate resources is equal to the threshold size.

If the size of the first set of multi-consecutive slots transmission candidate resources is equal to the threshold size, the method 300 may proceed to select a target resource from the first set of multi-consecutive slots transmission candidate resources, as indicated in block 340.

Otherwise, further evaluation may be needed. For example, the size of the first set of multi-consecutive slots transmission candidate resources shown in FIG. 4 is 6. In a case where the threshold size is set to 4, the size of the first set of multi-consecutive slots transmission candidate resources is not equal to the threshold size.

At block 350, the terminal device 110 determines whether the size of the first set of multi-consecutive slots transmission candidate resources is below the threshold size. If so, the first set of multi-consecutive slots transmission candidate resources does not meet a size condition, which may increase the probability of selecting the same resource with other terminal devices.

In this case, the method 300 proceeds to block 355. At block 355, the terminal device 110 may obtain a second set of multi-consecutive slots transmission candidate resources that was previously determined based on a second number of slots for multi-consecutive slots transmission, i.e., N_{slotMCSt_2}. The second number of slots for multi-consecutive slots transmission may be less than the first number of slots for multi-consecutive slots transmission N_{slotMCSt_1}. For example, N_{slotMCSt_}2=1, and in this case, the second set of multi-consecutive slots transmission candidate resources corresponds to the at least one group of single-slot candidate resources reported by L1. At block 360, the terminal device 110 may randomly select the target resource for transmission of the multi-consecutive slots transmission from the second set of multi-consecutive slots transmission candidate resources.

If the size of the first set of multi-consecutive slots transmission candidate resources is above the threshold size, the terminal device 110 may change the number of slots for multi-consecutive slots transmission. As a result, the set of multi-consecutive slots transmission candidate resources may be recomputed until a certain condition is met.

For example, as shown in FIG. 4, the size of the first set of multi-consecutive slots transmission candidate resources is 6, which is above the threshold size of 4, in this case, the method 300 may proceed to block 370.

At block 370, the terminal device 110 may determine a third number of slots for multi-consecutive slots transmission, i.e., N_{slotMCSt_3}, by increasing the first number of slots for multi-consecutive slots transmission by a predetermined number. For example, the first number of slots for multi-consecutive slots transmission N_{slotMCSt_1} may be incremented by 1, which leads to the third number of slots N_{slotMCSt_3}=3.

The terminal device 110 may then compare the increased number of slots with the required number of slots, e.g., the higher target number of slots. Accordingly, at block 375, the terminal device 110 may determine if the third number of slots for multi-consecutive slots transmission N_{slotMCSt_3} is above a target number of slots for multi-consecutive slots transmission.

If so, which means it has exceeded the requirement on the multi-consecutive slots transmission. In this case, the method 300 may turn back to block 340, and the terminal device 110 may select the target resource from the first set of multi-consecutive slots transmission candidate resources.

Otherwise, if the third number of slots for multi-consecutive slots transmission N_{slotMCSt_3} is not above the target number of slots for multi-consecutive slots transmission, the terminal device 110 may iterate to perform the determination at block 320 with the third number of slots N_{slotMCSt_3}. In this case, the terminal device 110 may determine, based on the third number of slots N_{slotMCSt_3}, a third set of multi-consecutive slots transmission candidate resources from the at least one group of single-slot candidate resources. Each of the third set of multi-consecutive slots transmission candidate resources may comprise the third number of consecutive slots.

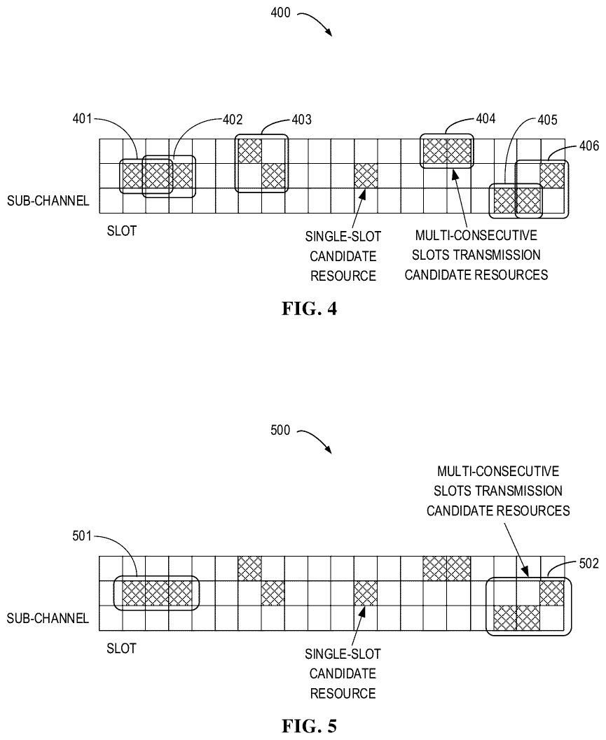

FIG. 5 illustrates a schematic diagram of example resource selection 500 of multi-consecutive slots transmission candidate resources, where N_{slotMCSt_3}=3. As shown in FIG. 5, the third set of multi-consecutive slots transmission candidate resources comprises multi-consecutive slots transmission candidate resources 501 and 502. Similar to the previous iteration with N_{slotMCSt_1}=2, the terminal device 110 may then evaluate the third set of multi-consecutive slots transmission candidate resources based on the threshold size. If the size of the third set of multi-consecutive slots transmission candidate resources is equal to the threshold size, the terminal device 110 may select the target resource from the third set of multi-consecutive slots transmission candidate resources. If the size of the third set of multi-consecutive slots transmission candidate resources is below the threshold size, the terminal device 110 may randomly select the target resource from the previous set, i.e., the first set of multi-consecutive slots transmission candidate resources. If the size of the third set of multi-consecutive slots transmission candidate resources is above the threshold size, the third number of slots for multi-consecutive slots transmission may be changed by increasing by the predetermined number, which leads to a fourth number of slots N_{slotMCSt_4}.

If the fourth number of slots N_{slotMCSt_4} is not above the target number of slots, a new iteration is triggered. Otherwise, if the fourth number of slots N_{slotMCSt_4} is above the target number of slots, the terminal device 110 may randomly select the target resource from the current set, i.e., the third set of multi-consecutive slots transmission candidate resources.

It should be understood that all the sets of multi-consecutive slots transmission candidate resources generated in different iterations may be stored at the terminal device 110.

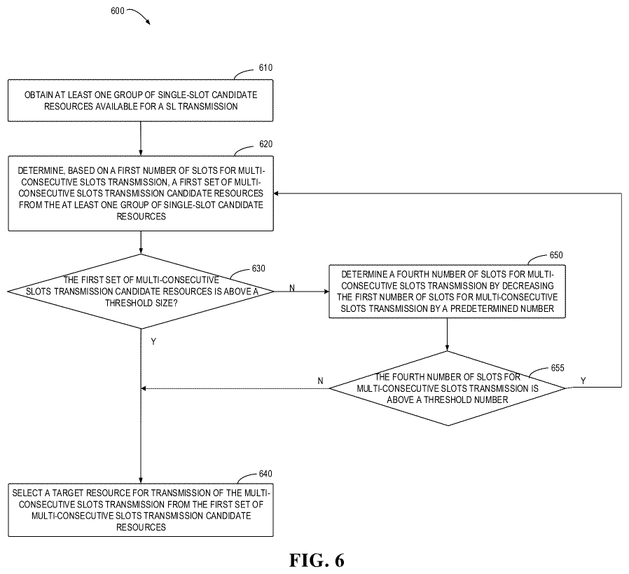

Reference is now made to FIG. 6, which illustrates a flowchart of a method 600 for resource selection that starts from a target number of slots for the multi-consecutive slots transmission. The method 600 may be implemented at an apparatus, for example, the terminal device 110. For the purpose of discussion, reference is made to FIG. 1 to describe the method 600.

Operations at blocks 610 and 620 are similar to those at blocks 210 and 220 in FIG. 2, thus details are not repeated herein. In the method 600, the first number of slots for multi-consecutive slots transmission N_{slotMCSt_1} is the required number of slots, i.e., the higher target number of slots. The higher target number of slots may be decreased until it can be used for generating a feasible set of multi-consecutive slots transmission candidate resources that meets the certain condition, such as, a minimum targeted size.

In the method 600, the first set of multi-consecutive slots transmission candidate resources is generated based on the higher target number of slots. The terminal device 110 may then evaluate the first set of multi-consecutive slots transmission candidate resources based on at least one multi-consecutive slots transmission candidate resource condition.

At block 630, the terminal device 110 may determine if the first set of multi-consecutive slots transmission candidate resources is above the threshold size, for example, the size of the first set of multi-consecutive slots transmission candidate resources is larger or equal to a minimum size of multi-consecutive slots transmission candidate resources set.

If so, the method 600 may proceed to block 640, where the terminal device 110 may select the target resource from the first set of multi-consecutive slots transmission candidate resources.

Otherwise, the method 600 may proceed to block 650. In this case, the terminal device 110 may change the first number of slots for multi-consecutive slots transmission. At block 650, the terminal device 110 may determine a fourth number of slots for multi-consecutive slots transmission, i.e., N_{slotMCSt_4}, by decreasing the first number of slots for multi-consecutive slots transmission N_{slotMCSt_1} by a predetermined number. For example, the first number of slots for multi-consecutive slots transmission N_{slotMCSt_1} may be decreased by 1, i.e., N_{slotMCSt_4}=N_{slotMCSt_1}−1.

The terminal device 110 may then compare the decreased number of slots with a threshold number, e.g., if N_{slotMCSt_4}>0. Accordingly, at block 655, the terminal device 110 may determine if the fourth number of slots for multi-consecutive slots transmission N_{slotMCSt_4} is above the threshold number.

If so, the terminal device 110 may iterate to perform the determination at block 620 with the fourth number of slots N_{slotMCSt_4}. In this case, the terminal device 110 may determine, based on the fourth number of slots N_{slotMCSt_4}, a fourth set of multi-consecutive slots transmission candidate resources from the at least one group of single-slot candidate resources. Each of the fourth set of multi-consecutive slots transmission candidate resources may comprise the fourth number of consecutive slots.

Otherwise, if the fourth number of slots for multi-consecutive slots transmission N_{slotMCSt_4} is not above the threshold number, the method 600 may turn back to block 640, and the terminal device 110 may select the target resource from the current set of multi-consecutive slots transmission candidate resources, i.e., the first set.

In some example embodiments, the generation of all the possible sets of multi-consecutive slots transmission candidate resources may be implemented with single-slot candidate reuse. This can possibly be configured or pre-configured. For example, when seeking for two consecutive slots for multi-consecutive slots transmission candidate resources, i.e., N_{slotMCSt}=2, and when three consecutive slots candidate resources have been identified, the terminal device 110 may only generate one multi-consecutive slots transmission candidate from these if the parameter is enabled. Otherwise, the terminal device 110 may generate 2 multi-consecutive slots transmission candidates (omitting the frequency domain aspect).

In some example embodiments, the scaling of the number of sub-channels may be computed for the total number of sub-channels, if more than one set of single-slot candidate resources is combined into a superset prior to computing the set of multi-consecutive slots candidate resources.

In some example embodiments, as an alternative of operations at blocks 330 and 370 and blocks 630 and 650, the search may also be based on a bisection search, i.e., increasing/decreasing by half the number of remaining resources between the preferred set of multi-consecutive slots candidate resources and the current set of multi-consecutive slots candidate resources.

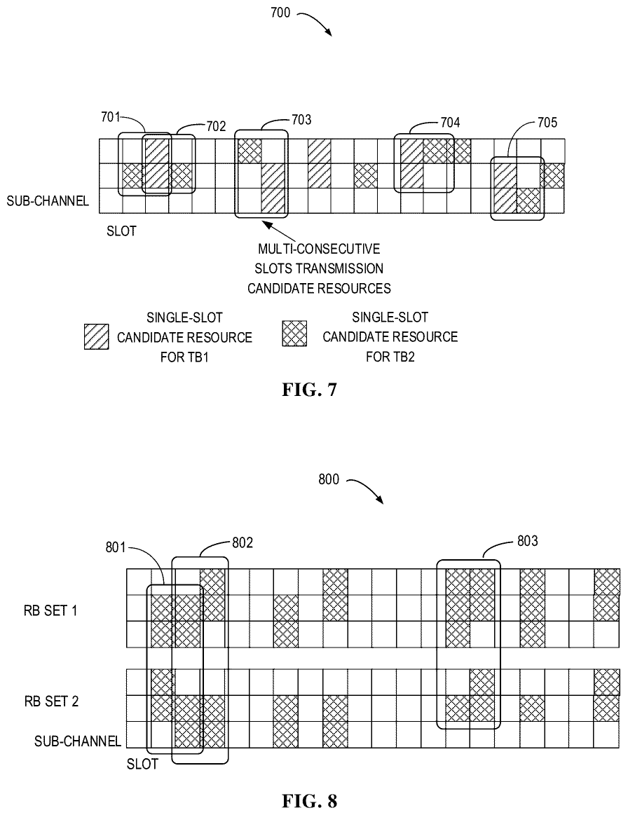

FIG. 7 illustrates a schematic diagram of example resource selection 700 of multi-consecutive slots transmission candidate resources for transmission of multiple TBs. As shown in FIG. 7, multi-consecutive slots candidate resources 701 to 705 are selected for TB 1 and TB 2. In this case, the number of sub-channels may vary from TB 1 and TB 2, and they can occur at different sub-channels.

FIG. 8 illustrates a schematic diagram of example resource selection 800 of multi-consecutive slots transmission candidate resources from multiple RB sets. For multiple RB sets, i.e., RB set 1 and RB set 2 (e.g., where the resource pool may span over multiple LBT channels of 20 MHz), in an example embodiment, a number of slots for multi-consecutive slots transmission may be combined per RB set, while the set of multi-consecutive slots transmission candidate resources may comprise all the generated combinations of all the RB sets. In another example embodiment, the multi-consecutive slots transmission candidate resources may comprise sub-channels of different RB sets, for example, multi-consecutive slots transmission candidate resources 801 to 803, the number of slots for multi-consecutive slots transmission may be combined across RB sets.

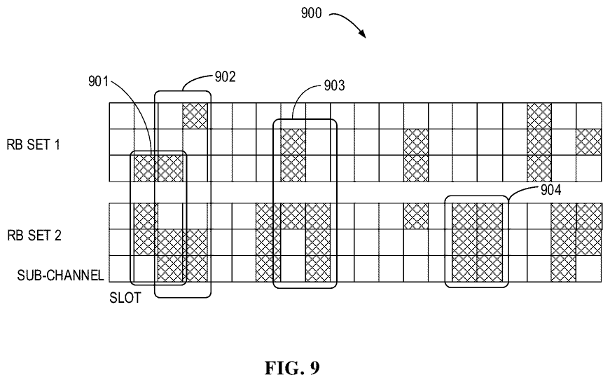

FIG. 9 illustrates a schematic diagram of example resource selection 900 of multi-consecutive slots transmission candidate resources from multiple RB sets. In the example embodiment, the combining for a number of slots for multi-consecutive slots transmission may consider that at least the first single-slot resource of a combination should have sub-channels from each RB set used during the multi-consecutive slots transmission, for example, the multi-consecutive slots transmission candidate resources 901 to 903, while the multi-consecutive slots transmission candidate resource 904 uses only the RB set 2.

In some example embodiments, an apparatus capable of performing any of the method 200 (for example, the terminal device 110 in FIG. 1) may comprise means for performing the respective operations of the method 200. The means may be implemented in any suitable form. For example, the means may be implemented in a circuitry or software module. The first apparatus may be implemented as or included in the terminal device 110 in FIG. 1.

In some example embodiments, the apparatus comprises means for obtaining at least one group of single-slot candidate resources available for a sidelink transmission; means for determining, based on a first number of slots for multi-consecutive slots transmission, a first set of multi-consecutive slots transmission candidate resources from the at least one group of single-slot candidate resources, a multi-consecutive slots transmission candidate resource comprising the first number of consecutive slots; means for in accordance with a determination that the first set of multi-consecutive slots transmission candidate resources meets at least one multi-consecutive slots transmission candidate resource condition, selecting a target resource for transmission of the multi-consecutive slots transmission from the first set of multi-consecutive slots transmission candidate resources; means for in accordance with a determination that the first set of multi-consecutive slots transmission candidate resources does not meet the at least one multi-consecutive slots transmission candidate resource condition, determining the target resource for transmission of the multi-consecutive slots transmission based on a multi-consecutive slots transmission criterion on a set size and/or a change of the first number of slots; and means for transmitting the multi-consecutive slots transmission on the target resource.

In some example embodiments, the sidelink transmission comprises a single transport block, TB, the first set of multi-consecutive slots transmission candidate resources is determined from a group of single-slot candidate resources, and the TB is repeated in each of the first number of consecutive slots, or the TB is spread across the first number of consecutive slots.

In some example embodiments, the sidelink transmission comprises a plurality of TBs, the first set of multi-consecutive slots transmission candidate resources is determined from a plurality of groups of single-slot candidate resources, and each of the plurality of TBs is repeated in a different one of the first number of consecutive slots, or each of the plurality of TB is spread across the first number of consecutive slots.

In some example embodiments, the at least one group of single-slot candidate resources corresponds to a plurality of resource block, RB, sets, and the first set of multi-consecutive slots transmission candidate resources is determined per RB set or across the plurality of contiguous or non-contiguous RB sets.

In some example embodiments, the at least one group of single-slot candidate resources corresponds to a plurality of resource block, RB, sets, and the first set of multi-consecutive slots transmission candidate resources comprises a first multi-consecutive slots transmission candidate resource that is determined across the plurality of contiguous or non-contiguous RB sets.

In some example embodiments, the at least one multi-consecutive slots transmission candidate resource condition comprises at least one of the following: a size of the first set of multi-consecutive slots transmission candidate resources is above a threshold size, the first set of multi-consecutive slots transmission candidate resources is evenly distributed within a selection window in time domain and/or frequency domain, or at least a part of the first set of multi-consecutive slots transmission candidate resources meets a preconfigured separation in the time domain to any other multi-consecutive slots transmission candidate resource in the first set of multi-consecutive slots transmission candidate resources.

In some example embodiments, the first number of slots for multi-consecutive slots transmission comprises a minimum number of slots for multi-consecutive slots transmission, and the at least one multi-consecutive slots transmission candidate resource condition comprises a size of the first set of multi-consecutive slots transmission candidate resources being equal to a threshold size, and in accordance with a determination that the first set of multi-consecutive slots transmission candidate resources does not meet the at least one multi-consecutive slots transmission candidate resource condition, the apparatus further comprises means for the following: determining whether the size of the first set of multi-consecutive slots transmission candidate resources is below the threshold size; in accordance with a determination that the size of the first set of multi-consecutive slots transmission candidate resources is below the threshold size, obtaining a second set of multi-consecutive slots transmission candidate resources that was previously determined based on a second number of slots for multi-consecutive slots transmission, the second number of slots for multi-consecutive slots transmission being less than the first number of slots for multi-consecutive slots transmission; and selecting the target resource for transmission of the multi-consecutive slots transmission from the second set of multi-consecutive slots transmission candidate resources; in accordance with a determination that the size of the first set of multi-consecutive slots transmission candidate resources is not below the threshold size, determining a third number of slots for multi-consecutive slots transmission by increasing the first number of slots for multi-consecutive slots transmission by a predetermined number; in accordance with a determination that the third number of slots for multi-consecutive slots transmission is above a target number of slots for multi-consecutive slots transmission, selecting the target resource from the first set of multi-consecutive slots transmission candidate resources; in accordance with a determination that the third number of slots for multi-consecutive slots transmission is not above the target number of slots for multi-consecutive slots transmission, determining, based on the third number of slots for multi-consecutive slots transmission, a third set of multi-consecutive slots transmission candidate resources from the at least one group of single-slot candidate resources, a multi-consecutive slots transmission candidate resource comprising the third number of consecutive slots; and determining whether to select the target resource for transmission of the multi-consecutive slots transmission from the third set of multi-consecutive slots transmission candidate resources based on the at least one multi-consecutive slots transmission candidate resource condition.

In some example embodiments, the first number of slots for multi-consecutive slots transmission comprises a target number of slots for multi-consecutive slots transmission, and the at least one multi-consecutive slots transmission candidate resource condition comprises a size of the first set of multi-consecutive slots transmission candidate resources being above a threshold size, and in accordance with a determination that the first set of multi-consecutive slots transmission candidate resources does not meet the at least one multi-consecutive slots transmission candidate resource condition, the apparatus further comprises means for the following: determining a fourth number of slots for multi-consecutive slots transmission by decreasing the first number of slots for multi-consecutive slots transmission by a predetermined number; in accordance with a determination that the fourth number of slots for multi-consecutive slots transmission is above a threshold number, determining, based on the fourth number of slots for multi-consecutive slots transmission, a fourth set of multi-consecutive slots transmission candidate resources from the at least one group of single-slot candidate resources, a multi-consecutive slots transmission candidate resource comprising the fourth number of consecutive slots; and determining whether to select the target resource for transmission of the multi-consecutive slots transmission from the fourth set of multi-consecutive slots transmission candidate resources based on the at least one multi-consecutive slots transmission candidate resource condition; and in accordance with a determination that the fourth number of slots for multi-consecutive slots transmission is not above the threshold number, selecting the target resource from the first set of multi-consecutive slots transmission candidate resources.

In some example embodiments, the first number of slots for multi-consecutive slots transmission is preconfigured or determined based on a ratio of the at least one group of single-slot candidate resources in a resource selection window.

In some example embodiments, wherein the target number of slots for multi-consecutive slots transmission is determined based on at least one of the following: a duration of a channel occupancy time, COT corresponding to a channel access priority class, CAPC, associated with the sidelink transmission, a periodicity of a physical sidelink feedback channel, PSFCH, associated with the sidelink transmission, a congestion metric of a channel busy ratio, CBR, associated with the sidelink transmission, or an amount of data in a buffer of the apparatus.

In some example embodiments, the predetermined number is one.

In some example embodiments, the predetermined number is determined by halving a difference between the target number of slots for multi-consecutive slots transmission and the first number of slots for multi-consecutive slots transmission.

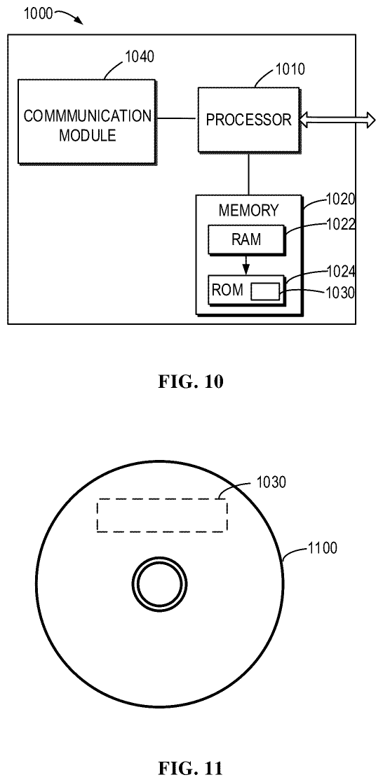

FIG. 10 illustrates a simplified block diagram of a device 1000 that is suitable for implementing example embodiments of the present disclosure. The device 1000 may be provided to implement a communication device, for example, the terminal apparatus 110 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 2 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 illustrates a block diagram of an example computer readable medium 1000 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the fore going. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus comprising:
at least one processor; and
at least one memory storing instructions that, when executed by the at least one processor, cause the apparatus at least to:
obtain at least one group of single-slot candidate resources available for a sidelink transmission;
determine, based on a first number of slots for multi-consecutive slots transmission, a first set of multi-consecutive slots transmission candidate resources from the at least one group of single-slot candidate resources, a multi-consecutive slots transmission candidate resource comprising the first number of consecutive slots;
determine that the first set of multi-consecutive slots transmission candidate resources meets at least one multi-consecutive slots transmission candidate resource condition;
select a target resource for transmission of the multi-consecutive slots transmission from the first set of multi-consecutive slots transmission candidate resources;
transmit the multi-consecutive slots transmission on the target resource.

2. The apparatus of claim 1, wherein, in accordance with a determination that the first set of multi-consecutive slots transmission candidate resources does not meet the at least one multi-consecutive slots transmission candidate resource condition, the apparatus is caused to determine the target resource for transmission of the multi-consecutive slots transmission based on a multi-consecutive slots transmission criterion on a set size and/or a change of the first number of slots;

3. The apparatus of claim 1, wherein the sidelink transmission comprises a single transport block, TB, the first set of multi-consecutive slots transmission candidate resources is determined from a group of single-slot candidate resources, and the TB is repeated in each of the first number of consecutive slots, or the TB is spread across the first number of consecutive slots.

4. The apparatus of claim 1, wherein the sidelink transmission comprises a plurality of TBs, the first set of multi-consecutive slots transmission candidate resources is determined from a plurality of groups of single-slot candidate resources, and each of the plurality of TBs is repeated in a different one of the first number of consecutive slots, or each of the plurality of TB is spread across the first number of consecutive slots.

5. The apparatus of claim 1, wherein the at least one group of single-slot candidate resources corresponds to a plurality of resource block, RB, sets, and the first set of multi-consecutive slots transmission candidate resources is determined per RB set or across the plurality of contiguous or non-contiguous RB sets.

6. The apparatus of claim 1, wherein the at least one group of single-slot candidate resources corresponds to a plurality of resource block, RB, sets, and the first set of multi-consecutive slots transmission candidate resources comprises a first multi-consecutive slots transmission candidate resource that is determined across the plurality of contiguous or non-contiguous RB sets.

7. The apparatus of claim 1, wherein the at least one multi-consecutive slots transmission candidate resource condition comprises at least one of the following:
a size of the first set of multi-consecutive slots transmission candidate resources is above a threshold size,
the first set of multi-consecutive slots transmission candidate resources is evenly distributed within a selection window in time domain and/or frequency domain, or
at least a part of the first set of multi-consecutive slots transmission candidate resources meets a preconfigured separation in the time domain to any other multi-consecutive slots transmission candidate resource in the first set of multi-consecutive slots transmission candidate resources.

8. The apparatus of claim 2, wherein the first number of slots for multi-consecutive slots transmission comprises a minimum number of slots for multi-consecutive slots transmission, and the at least one multi-consecutive slots transmission candidate resource condition comprises a size of the first set of multi-consecutive slots transmission candidate resources being equal to a threshold size, and
wherein in accordance with a determination that the first set of multi-consecutive slots transmission candidate resources does not meet the at least one multi-consecutive slots transmission candidate resource condition, the apparatus is further caused to:
determine whether the size of the first set of multi-consecutive slots transmission candidate resources is below the threshold size;
in accordance with a determination that the size of the first set of multi-consecutive slots transmission candidate resources is below the threshold size,
obtain a second set of multi-consecutive slots transmission candidate resources that was previously determined based on a second number of slots for multi-consecutive slots transmission, the second number of slots for multi-consecutive slots transmission being less than the first number of slots for multi-consecutive slots transmission; and
select the target resource for transmission of the multi-consecutive slots transmission from the second set of multi-consecutive slots transmission candidate resources;
in accordance with a determination that the size of the first set of multi-consecutive slots transmission candidate resources is not below the threshold size,
determine a third number of slots for multi-consecutive slots transmission by increasing the first number of slots for multi-consecutive slots transmission by a predetermined number;
in accordance with a determination that the third number of slots for multi-consecutive slots transmission is above a target number of slots for multi-consecutive slots transmission, select the target resource from the first set of multi-consecutive slots transmission candidate resources;
in accordance with a determination that the third number of slots for multi-consecutive slots transmission is not above the target number of slots for multi-consecutive slots transmission,
determine, based on the third number of slots for multi-consecutive slots transmission, a third set of multi-consecutive slots transmission candidate resources from the at least one group of single-slot candidate resources, a multi-consecutive slots transmission candidate resource comprising the third number of consecutive slots; and
determine whether to select the target resource for transmission of the multi-consecutive slots transmission from the third set of multi-consecutive slots transmission candidate resources based on the at least one multi-consecutive slots transmission candidate resource condition.

9. The apparatus of claim 2, wherein the first number of slots for multi-consecutive slots transmission comprises a target number of slots for multi-consecutive slots transmission, and the at least one multi-consecutive slots transmission candidate resource condition comprises a size of the first set of multi-consecutive slots transmission candidate resources being above a threshold size, and
wherein in accordance with a determination that the first set of multi-consecutive slots transmission candidate resources does not meet the at least one multi-consecutive slots transmission candidate resource condition, the apparatus is further caused to:
determine a fourth number of slots for multi-consecutive slots transmission by decreasing the first number of slots for multi-consecutive slots transmission by a predetermined number;
in accordance with a determination that the fourth number of slots for multi-consecutive slots transmission is above a threshold number,
determine, based on the fourth number of slots for multi-consecutive slots transmission, a fourth set of multi-consecutive slots transmission candidate resources from the at least one group of single-slot candidate resources, a multi-consecutive slots transmission candidate resource comprising the fourth number of consecutive slots; and
determine whether to select the target resource for transmission of the multi-consecutive slots transmission from the fourth set of multi-consecutive slots transmission candidate resources based on the at least one multi-consecutive slots transmission candidate resource condition; and
in accordance with a determination that the fourth number of slots for multi-consecutive slots transmission is not above the threshold number, select the target resource from the first set of multi-consecutive slots transmission candidate resources.

10. The apparatus of claim 1, wherein the first number of slots for multi-consecutive slots transmission is preconfigured or determined based on a ratio of the at least one group of single-slot candidate resources in a resource selection window.

11. The apparatus of claim 8, wherein the target number of slots for multi-consecutive slots transmission is determined based on at least one of the following:
a duration of a channel occupancy time, COT corresponding to a channel access priority class, CAPC, associated with the sidelink transmission,
a periodicity of a physical sidelink feedback channel, PSFCH, associated with the sidelink transmission,
a congestion metric of a channel busy ratio, CBR, associated with the sidelink transmission, or
an amount of data in a buffer of the apparatus.

12. The apparatus of claim 8, wherein the predetermined number is one.

13. The apparatus of claim 8, wherein the predetermined number is determined by halving a difference between the target number of slots for multi-consecutive slots transmission and the first number of slots for multi-consecutive slots transmission.

14. A method comprising:
obtaining, at an apparatus, at least one group of single-slot candidate resources available for a sidelink transmission;
determining, based on a first number of slots for multi-consecutive slots transmission, a first set of multi-consecutive slots transmission candidate resources from the at least one group of single-slot candidate resources, a multi-consecutive slots transmission candidate resource comprising the first number of consecutive slots;
determining that the first set of multi-consecutive slots transmission candidate resources meets at least one multi-consecutive slots transmission candidate resource condition;
selecting a target resource for transmission of the multi-consecutive slots transmission from the first set of multi-consecutive slots transmission candidate resources;
and
transmitting the multi-consecutive slots transmission on the target resource.

15. A computer readable medium comprising instructions stored thereon for causing an apparatus at least to perform the method of claim 14.
